(19) United States
(12) Patent Application Publication
(10) Pub. No.: US 2004/0213468 A1
(43) Pub. Date: Oct. 28, 2004

(54) Method for determining reference picture and motion compensation method and apparatus thereof

(75) Inventors: Nam-suk Lee, Seoul (KR); Hyeong-seok Ha, Suwon-si (KR); So-young Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/788,268

(22) Filed: Mar. 1, 2004

(30) Foreign Application Priority Data
Apr. 28, 2003 (KR) 2003-26678

(51) Int. Cl. G06K 9/36; G06K 9/46

(52) U.S. Cl. 382/236; 382/239; 382/238

(57) ABSTRACT

A method for determining a reference picture and motion compensation method and apparatus thereof are provided. The method for determining reference pictures for a plurality of blocks forming a current picture comprises determining reference pictures for part of the plurality of blocks; and determining a reference picture that is most frequently selected among reference pictures of blocks which are adjacent to the remaining blocks and for which reference pictures are already determined, as the reference picture of the remaining blocks. According to the method, the efficiency of compression improves and complexity of computation can be reduced in coding and decoding data.

This application claims the priority of Korean Patent Application No. 03-26678, filed Apr. 28, 2003, the disclosure of which is incorporated herein by reference in its entirety.

### BACKGROUND OF THE INVENTION

1. Field of the Invention

The present invention relates to a reference picture for coding or decoding moving pictures, and more particularly, to a method for determining reference pictures for a plurality of blocks forming a picture, and motion compensation method and apparatus thereof.

2. Description of the Related Art

According to H.264 standard prepared by the International Telecommunication Union for high compression coding and decoding of moving picture data, coding or decoding is performed in units of macroblocks, a plurality of which are included in a picture, or in units of sub-blocks, which are obtained by dividing or quartering a macroblock. Coding and decoding are performed based on prediction. Prediction is performed by referring to a past picture or to both a past picture and a future picture on a time axis. A picture referred to in order to code or decode a current picture is called as a reference picture.

According to the H.264 standard, a macroblock and/or a sub-block can refer to different reference pictures, respectively. That is, with a plurality of pictures, each performs motion estimation, determines a reference picture with a picture having the highest compression efficiency, and by using the determined reference picture, obtains a motion vector. Accordingly, compared to the prior art methods which use only one reference picture, compression efficiency increases and the display quality improves.

However, in order to use a plurality of reference pictures for coding a current picture, the reference pictures should be stored and as a result the load on memory increases. In addition, an optical reference picture is selected after motion estimation is performed for each of the plurality of reference pictures such that the amount of computation greatly increases.

### SUMMARY OF THE INVENTION

The present invention provides a method for determining a reference picture, by which the efficiency of compression improves and the amount of computation is reduced by using a plurality of reference pictures. A motion estimation method and apparatus thereof is also disclosed.

The present invention also provides a motion estimation method and an apparatus by using a reference picture which is determined so that the efficiency of compression improves and the amount of computation is reduced.

According to one aspect of the present invention, there is provided a method for determining reference pictures for a plurality of blocks forming a current picture comprising: determining reference pictures for part of the plurality of blocks; and determining a reference picture that is most frequently selected among reference pictures of blocks which are adjacent to the remaining blocks and for which reference pictures are already determined, as the reference picture of the remaining blocks.

In determining the reference picture of the remaining blocks, if there are a plurality of reference pictures that are most frequently selected, a picture which is selected among the plurality of reference pictures according to a predetermined criterion is determined as the reference picture.

In determining the reference picture of the remaining blocks, if the reference pictures of the blocks which are adjacent to the remaining blocks and for which reference pictures are already determined are all different, a picture which is selected from among the different reference pictures according to a predetermined criterion is determined as the reference picture of the remaining blocks.

In determining the reference picture of the remaining blocks, a picture having the highest compression efficiency for the remaining blocks is determined as the reference picture.

According to another aspect of the present invention, there is provided a method for performing motion compensation comprising: reading a reference picture which is obtained by first determining reference pictures for part of a plurality of blocks forming a current picture, and then determining a reference picture that is most frequently selected among reference pictures of blocks which are adjacent to the remaining blocks and for which reference pictures are already determined, as the reference picture of the remaining blocks; and by using the read reference picture and a motion vector corresponding to the reference picture, performing motion compensation.

In determining the reference picture, if there are a plurality of reference pictures that are determined to be the most frequently selected, a picture having the highest compression efficiency among the plurality of reference pictures is determined as the reference picture.

In determining the reference picture, if the reference pictures of the blocks which are adjacent to the remaining blocks and for which reference pictures are already determined are all different, a picture having the highest compression efficiency among the different reference pictures is determined as the reference picture.

According to still another aspect of the present invention, there is provided an apparatus for coding moving picture data comprising: a motion prediction unit which first determines reference pictures for part of a plurality of blocks included in a picture forming the moving picture data, then determines a reference picture that is most frequently selected among reference pictures of blocks which are adjacent to the remaining blocks and for which reference pictures are already determined, as the reference picture of the remaining blocks, and calculates a motion vector for the block from the determined reference picture; a memory unit which stores the reference picture determined by the motion prediction unit; and a motion compensation unit which performs motion compensation by using the motion vector calculated by the motion prediction unit and the reference pictures stored in the memory unit.

According to yet another aspect of the present invention, there is provided an apparatus for decoding a bitstream containing coded moving picture data comprising: a memory unit which stores reference picture indices indicating reference pictures, which are determined by first determining reference pictures for part of a plurality of blocks included in a current picture forming the moving picture data, then determining a reference picture that is most frequently selected among reference pictures of blocks which are adjacent to the remaining blocks and for which reference pictures are already determined, as the reference picture of the remaining blocks, and reference pictures indicated by the reference pictures indices; a vector decoding unit which decodes a motion vector extracted from the bitstream; and a motion compensation unit which performs motion compensation by using a reference picture read from the memory unit and a corresponding motion vector provided by the motion vector decoding unit.

If there are a plurality of reference pictures that are determined as the most frequently selected, the reference picture index indicates a picture having the highest compression efficiency among the plurality of reference pictures.

If the reference pictures of the blocks which are adjacent to the current block and for which reference pictures are already determined are all different, the reference picture index indicates a picture having the highest compression efficiency among the different reference pictures.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a coding apparatus according to a preferred embodiment of the present invention;

FIG. 2 is a block diagram of a decoding apparatus according to a preferred embodiment of the present invention;

FIG. 3 is a reference diagram to explain a multiple reference method according to the present invention;

FIG. 4 is a reference diagram to show blocks that are units for reference picture determination and motion compensation thereof according to the present invention;

FIGS. 5 through 7 are schematic diagrams of a current picture in which blocks that are selected to first determine reference pictures are displayed;

FIGS. 8 and 9 are reference diagrams showing examples of methods defining neighbor blocks for a current block in a method for determining a reference picture according to the present invention; and

FIGS. 10 through 16 are reference diagrams for explaining a method for determining reference pictures of the remaining blocks forming a current picture based on the neighbor blocks of FIG. 8 according to the present invention.

### DESCRIPTION OF THE PREFERRED EMBODIMENTS

A coding apparatus according to the present invention encodes moving picture data. Moving picture data comprise a plurality of pictures having a frame or field structure, and a picture is formed with a plurality of blocks. A frame is a progressive scanning frame obtained by a progressive scanning method or an interlaced scanning frame obtained by an interlaced scanning method. A field is a top field or a bottom field forming an interlaced scanning frame. A block includes a macroblock or a sub-block obtained by dividing or quartering a macroblock in the vertical or horizontal direction.

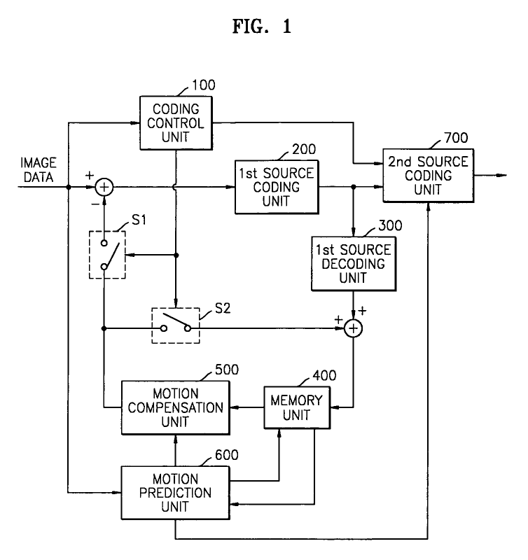

FIG. 1 is a block diagram of a coding apparatus according to a preferred embodiment of the present invention.

Referring to FIG. 1, a coding apparatus in accordance with the present invention employs a multiple reference method, by which a plurality of past pictures and/or future pictures can be referred to in coding a current picture, and comprises a coding control unit 100, a first source coding unit 200, and a second source coding unit 700. The coding apparatus also comprises a first source decoding unit 300, a memory unit 400, a motion compensation unit 500, and a motion prediction unit 600. Here, as will be described, the motion compensation unit 500 performs motion compensation according to the present invention and the motion prediction unit 600 determines a reference picture and performs motion prediction by using the determined reference picture according to the present invention.

If image data is input, the coding control unit 100 determines a coding type e.g., (intra-coding/inter-coding) depending on whether or not it is desired to perform motion compensation of an input image, and outputs a control signal, corresponding to the type, to the first switch (S1). When motion compensation is performed, that is, when inter-coding is performed, image data which are input previously, and/or after the current data, is needed and the first switch (S1) is closed. When motion compensation is not performed, that is, when intra-coding is performed, image data which are input before, and/or after the current data, is not needed and the first switch (S2) is open. If the first switch (S1) is closed, the input image and second video data, which are obtained from image data input previously and/or after the input image, are input to the first source coding unit 200, and if the first switch (S1) is open, only the input image is input to the first source coding unit 200.

In the present embodiment, when the first switch (S1) is open, image data which is input to the first source coding unit 200 is “I-pictures”. When the first switch (S1) is closed, image data which is input to the first source coding unit 200 is “P-pictures” or “B-pictures”. That is, video data that is the object of coding is formed with a plurality of pictures. I-pictures are intra pictures obtained without reference to other pictures. B-pictures are bidirectional pictures obtained with reference to two different pictures. P-pictures are predictive pictures obtained with reference only to I-pictures. In the present embodiment, coding is performed in units of macroblocks forming a picture, or in units of sub-blocks, which are obtained by dividing or quartering a macroblock. Accordingly, blocks that will be mentioned indicate a plurality of blocks forming a picture, more specifically, macroblocks, or sub-blocks which are obtained by dividing or quartering a macroblock.

The first source coding unit 200 converts a picture, obtains transform coefficients, quantizes the coefficients according to a predetermined quantization steps, and outputs quantized transform coefficients. Examples of transforms that can be used include discrete cosine transform (DCT) and wavelet transform. Quantization is performed according to the predetermined quantization steps.

Meanwhile, since the current picture which is input and coded in the first source coding unit 200 can be used as a reference picture for motion compensation of a block that is input previously or after the current picture, the current picture is stored in the memory unit 400 after passing through the first source decoding unit 300 in which inverse-quantization and inverse-transform that are the inverse processes of the processes performed in the first source coding unit 200 are performed.

The motion prediction unit 600 determines a reference picture according to the present invention. That is, reference pictures for part of a plurality of blocks included in a current picture are first determined and then, a reference picture most frequently selected among the reference pictures of blocks, which are adjacent to the remaining blocks and for which reference pictures are determined, is determined as the reference picture for the remaining pictures. If the number of reference pictures that are most frequently selected is more than one, a reference picture with the highest compression efficiency among the plurality of reference pictures is determined as the reference picture. If the reference pictures of blocks, which are adjacent to the remaining blocks and for which reference pictures are determined, are all different, a reference picture with the highest compression efficiency among the different reference pictures is determined as the reference picture. The determination of a reference picture will be explained later in detail. A motion vector is calculated by referring to a plurality of past and/or future pictures

The motion compensation unit 500 reads a reference picture indicated by a motion vector calculated by the motion prediction unit 600, from the memory unit 400 and performs motion compensation based on the reference picture and the motion vector, and outputs the motion compensation value thus obtained. The motion compensation value is added with data output from the first source decoding unit 300, reconstructed to a picture forming input image data, and stored in the memory unit 400 to be used for motion prediction or motion compensation.

The second source coding unit 700 receives quantized transform coefficients output from the first source coding unit 200, a motion vector output from the motion prediction unit 600, and information needed in decoding, such as coding-type information and quantization step information, from the coding control unit 100, encodes the data respectively, and outputs bitstreams. In the present embodiment, the second source coding unit 700 performs entropy coding.

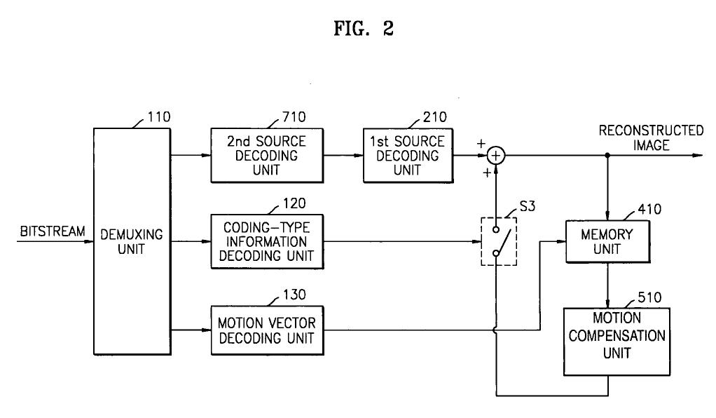

FIG. 2 is a block diagram of a decoding apparatus according to a preferred embodiment of the present invention.

Referring to FIG. 2, the decoding apparatus decodes bitstreams containing moving picture data coded by the coding apparatus of FIG. 1, and comprises a demuxing unit 110, which demuxes a bitstream, a second source decoding unit 710, and a first source decoding unit 210. The decoding apparatus also comprises a coding-type information decoding unit 120, which decodes coding-type information, and a motion vector decoding unit 130, which decodes a motion vector. The decoding apparatus further comprises a memory unit 410 and a motion compensation unit 510.

The demuxing unit 110 demuxes a received bitstream and outputs coded and quantized transform coefficients, motion vector information, and coding-type information. The second source decoding unit 710 entropy-decodes coded transform coefficients and outputs quantized transform coefficients. The first source decoding unit 210 first-source-decodes the quantized transform coefficients. That is, the inverse process of the process performed by the first source coding unit 200 of FIG. 1 is performed. For example, if the first source coding unit performs DCT, the first source decoding unit 210 performs inverse DCT (IDCT). Likewise, if the first source coding unit 200 performs wavelet transform, the first source decoding unit 210 performs inverse wavelet transform. As a result, a picture forming moving picture data is reconstructed. The reconstructed picture is stored in the memory unit 410 for motion compensation.

Meanwhile, the coding-type information decoding unit 120 decodes the coding type and learns the coding type. If the coding type is an inter type which needs motion compensation, the third switch (S3) is closed and the data output from the first source decoding unit 210 is added with a motion compensation value output from the motion compensation unit 510 so that a reconstructed picture can be obtained. The motion vector decoding unit 130 decodes a motion vector, while the motion compensation unit 510 outputs a motion compensation value generated by using a reference picture indicated by the decoded motion vector.

In particular, in order to perform motion compensation, the motion compensation unit 510 uses a reference picture determined according to the present invention. That is, reference pictures for part of a plurality of blocks included in a current picture are first determined and a reference picture most frequently selected among the reference pictures of blocks, which are adjacent to the remaining blocks and for which reference pictures are determined, is determined as the reference picture for the remaining pictures. If the number of reference pictures that are most frequently selected is more than one, a reference picture with the highest compression efficiency among the plurality of reference pictures is determined as the reference picture. If the reference pictures of blocks, which are adjacent to the remaining blocks and for which reference pictures are determined, are all different, a reference picture with the highest compression efficiency among the different reference pictures is determined as the reference picture. This will be explained later in detail.

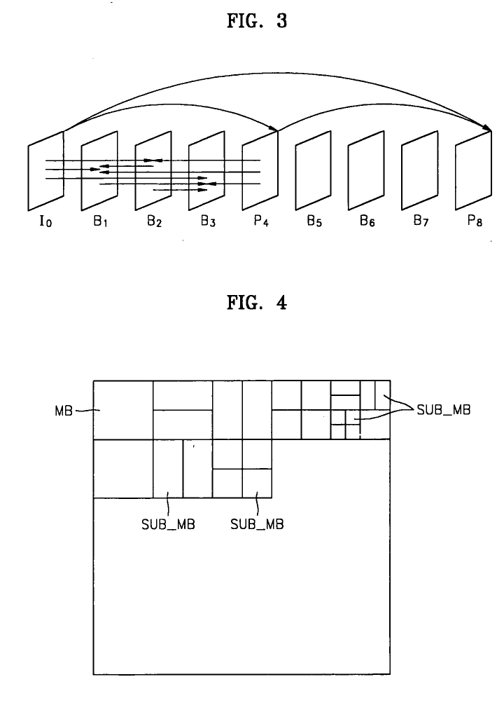

FIG. 3 is a reference diagram for explaining a multiple reference method according to the present invention.

Referring to FIG. 3, moving picture data comprises I-pictures, B-pictures, and P-pictures. The multiple reference method is a method, by which a plurality of past and/or future pictures are referred to when B-pictures or P-pictures are coded or decoded. For example, the arrows in FIG. 3 indicate pictures needed for coding/decoding, that is, the arrows show the dependency relationships for reference. For example, picture B₂ depends on pictures I₀ and P₄, picture B₁ on pictures I₀, P₄, and B₂. Picture B₃ depends on pictures I₀, P₄, B₁, and B₂. Accordingly, though the display order is I₀, B₁, B₂, B₃, P₄, . . . , the transmission order is I₀, P₄, B₂, B₁, B₃, . . . . Therefore, the motion vector is calculated by at least one of a forward prediction method, a backward prediction method, a bidirectional prediction method, and a direct prediction method.

FIG. 4 is a reference diagram to show blocks that are units for reference picture determination and motion compensation thereof according to the present invention.

Referring to FIG. 4, a picture comprises a plurality of blocks.

In addition to 16×16 macroblocks (MB) according to the present embodiment, the blocks include 8×16 blocks obtained by equally dividing macroblocks in the horizontal direction, 16×8 blocks obtained by equally dividing macroblocks in the vertical direction, 8×8 blocks obtained by equally dividing macroblocks in the horizontal direction and in the vertical direction, 4×8 blocks or 8×4 blocks obtained by dividing 8×8 blocks in the horizontal or vertical direction, and 4×4 blocks obtained by dividing 8×8 blocks in the horizontal direction and in the vertical direction.

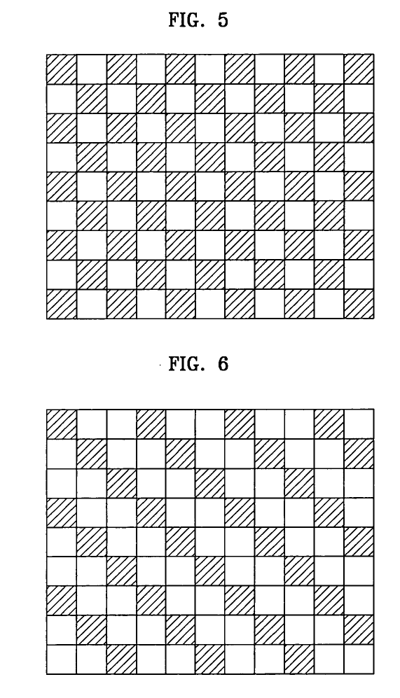

FIGS. 5 through 7 are schematic diagrams of a current picture in which blocks that are selected to first determine reference pictures are displayed.

As described above, the method for determining a reference picture according to the present invention, part of a plurality of blocks forming a current picture, the part for which reference pictures should be first determined, should be selected. The method for the selection may be performed in a variety of ways without any specific condition. However, in order to determine reference pictures of all blocks forming the current picture by a determination method according to the present invention, each of the remaining blocks that are not selected should have at least one block for which a reference picture is already determined, among its neighbor blocks. When necessary, that is, by considering the characteristic of moving picture data, system resources, channel characteristics and so on, a selection method with a condition that there should be at least N blocks, for which reference pictures are already determined among neighbor blocks, may be determined. Further, a selection method with a condition that the number of neighbor blocks, for which reference pictures are already determined, should be in a range between P and Q (P<Q; where P and Q are integers) may be determined.

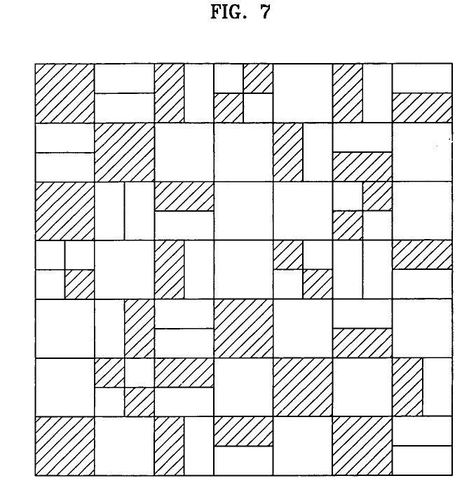

Referring to FIGS. 5 through 7, shaded blocks indicate the blocks which are selected to first determine reference pictures according to a predetermined algorithm. According to the embodiment of FIG. 5, blocks, for which reference pictures are to be first determined among blocks forming a current picture, are alternately selected by using any one block that is determined first by any one of existing methods. According to the embodiment of FIG. 6, it is shown that every third block is selected in the row direction. According to the embodiment of FIG. 7, it is shown that shaded blocks are pseudo-randomly selected. In addition to these embodiments, numerous examples can exist.

With the selected blocks, for example, after performing motion estimation for each of the reference pictures in a predetermined range, a reference picture having the highest compression efficiency can be determined as the reference picture. The algorithm itself for determining a reference picture for each of the selected partial blocks can be selected from prior art algorithms according to requirements such as the characteristics of data to be coded, hardware specification and user requirements. For example, algorithms used in MPEG-1, MPEG-2, MPEG-4, and other coding and decoding methods can be used undoubtedly and algorithms to be developed in the future can also be applied. In the present embodiment, the algorithm for selecting a reference picture as defined in the H.264 standard is employed.

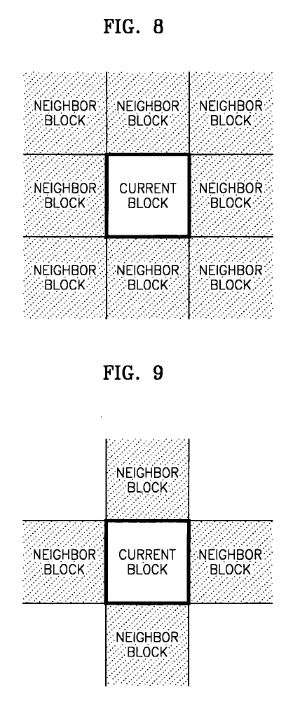

FIGS. 8 and 9 are reference diagrams showing examples of methods defining neighbor blocks for a current block in a method for determining a reference picture according to the present invention.

Depending on which blocks the range of neighbor blocks is determined, the specific implementation of a method for determining a reference picture according to the present invention may vary. That is, 1) in order to select blocks for which reference pictures should be first determined among a plurality of blocks forming a current picture by any one of existing methods, a condition that the remaining blocks should have at least one neighbor block for which a reference picture is already determined may have to be satisfied, or 2) as will be described, different algorithms for determining reference pictures for the remaining blocks may be employed.

Referring to FIG. 8, in the present embodiment, neighbor blocks of a current block include blocks sharing any one of four corners of the current block with the current block as well as blocks sharing any one of the four edges of the current block. That is, eight blocks surrounding the current block are neighbor blocks.

Referring to FIG. 9, in the present embodiment, neighbor blocks of a current block indicate only the blocks sharing any one of the four edges of the current block. That is, the blocks sharing any one of the four corners of the current block are not included, unlike in FIG. 8.

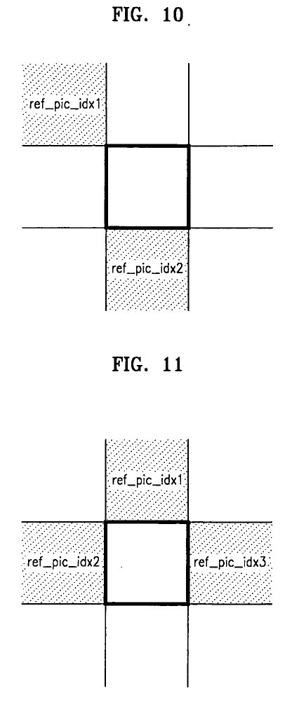

FIGS. 10 through 16 are reference diagrams for explaining a method for determining reference pictures of the remaining blocks forming a current picture based on the neighbor blocks of FIG. 8 according to the present invention.

The boundary of the current block is expressed by thick lines. Among the neighbor blocks of the current block, shaded blocks indicate the blocks for which reference pictures are already determined according to a predetermined algorithm. In the present embodiment, the number of shaded blocks can be in a range between 2 and 8.

FIG. 10 shows an example where the number of blocks which are adjacent to the current block and for which reference pictures are already determined is 2. That is, if the number of such neighbor blocks is N, N is 2. When it is assumed that reference picture indices indicating the reference pictures of the two blocks for which reference pictures are already determined are ref_pic_idx 1 and ref_pic_idx 2, respectively, in an arbitrary order, if ref_pic_idx 1 and ref_pic_idx 2 are identical, the reference picture indicated by the reference picture indices ref_pic_idx 1=ref_pic_idx 2 is determined as the reference picture of the current block. If ref_pic_idx 1 and ref_pic_idx 2 are different, motion prediction is performed for each of the reference pictures indicated by ref_pic_idx 1 and ref_pic_idx 2, and then a reference picture having the better compression efficiency is determined as the reference picture of the current block. In other words, a reference picture index indicating a picture with the better compression efficiency becomes the reference picture index of the current block.

FIG. 11 shows an example where the number of blocks which are adjacent to the current block and for which reference pictures are already determined is 3. That is, if the number of such neighbor blocks is N, N is 3. When it is assumed that reference picture indices indicating the reference pictures of the three blocks are ref_pic_idx 1, ref_pic_idx 2, and ref_pic_idx 3, respectively, in an arbitrary order, if ref_pic_idx 1, ref_pic_idx 2, and ref_pic_idx 3 are identical, the reference picture indicated by the reference picture indices ref_pic_idx 1=ref_pic_idx 2=ref_pic_idx 3 is determined as the reference picture of the current block. If any two indices of ref_pic_idx 1, ref_pic_idx 2, and ref_pic_idx 3 are identical and the remaining one is different, the reference picture indicated by the identical two reference picture indices is determined as the reference picture of the current block. If ref_pic_idx 1, ref_pic_idx 2, and ref_pic_idx 3 are all different, motion prediction is performed for each of the reference pictures and a reference picture having the better compression efficiency is determined as the reference picture of the current block. In other words, a reference picture index indicating a picture with the better compression efficiency becomes the reference picture index of the current block.

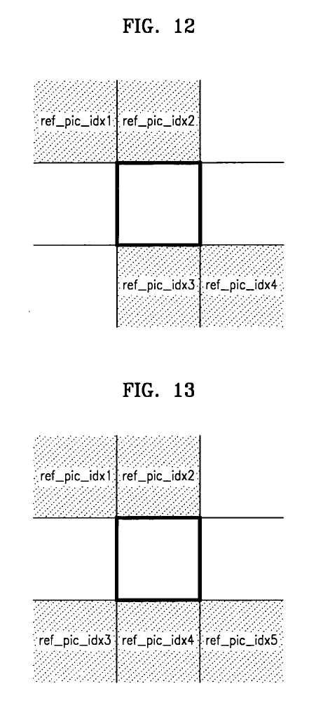

FIG. 12 shows an example where the number of blocks which are adjacent to the current block and for which reference pictures are already determined is 4. That is, if the number of such neighbor blocks is N, N is 4. When it is assumed that reference picture indices indicating the reference pictures of the four blocks are ref_pic_idx 1, ref_pic_idx 2 ref_pic_idx 3 and ref pic_idx 4, respectively, in an arbitrary order, if three or more of ref_pic_idx 1, ref_pic_idx 2, ref_pic_idx 3, and ref_pic_idx 4 are identical, that is, for example, if ref_pic_idx 1=ref_pic_idx 2=ref_pic_idx 3=ref_pic_idx 4, or if ref_pic_idx 1=ref_pic_idx 2=ref_pic_idx 3≠ref_pic_idx 4, the reference picture indicated by the three or more reference picture indices is determined as the reference picture of the current block. If ref_pic_idx 1, ref_pic_idx 2, ref_pic_idx 3 and ref_pic_idx 4 are divided into two groups, each group formed with identical indices, that is, if ref_pic_idx 1=ref_pic_idx 2≠ref_pic_idx 3=ref_pic_idx 4, motion prediction is performed for each of ref_pic_idx 1 and ref_pic_idx 3, and a reference picture having the better compression efficiency is determined as the reference picture of the current block. If only two of ref_pic_idx 1, ref_pic_idx 2, ref_pic_idx 3 and ref_pic_idx 4 are identical, that is, if ref_pic_idx 1=ref_pic_idx 2≠ref_pic_idx 3≠ref_pic_idx 4, the reference picture index of the two is determined as the reference picture index of the current block. If ref_pic_idx 1, ref_pic_idx 2, ref_pic_idx 3 and ref_pic_idx 4 are all different, motion prediction is performed for all the indices, and a reference picture index indicating a picture with the better compression efficiency is determined as the reference picture of the current block.

FIG. 13 shows an example where the number of blocks which are adjacent to the current block and for which reference pictures are already determined is 5. That is, if the number of such neighbor blocks is N, N is 5. When it is assumed that reference picture indices indicating the reference pictures of the five blocks are ref_pic_idx 1, ref_pic_idx 2, ref_pic_idx 3, ref_pic_idx 4 and ref_pic_idx 5, respectively, in an arbitrary order, if three or more of ref_pic_idx 1, ref_pic_idx 2, ref_pic_idx 3, ref_pic_idx 4 and ref_pic_idx 5 are identical, that is, for example, if ref_pic_idx 1=ref_pic_idx 2=ref_pic_idx 3=ref_pic_idx 4=ref_pic_idx 5, or if ref_pic_idx 1=ref_pic_idx 2=ref_pic_idx 3=ref_pic_idx 4≠ref_pic_idx 5, or if ref_pic_idx 1=ref_pic_idx 2=ref_pic_idx 3≠ref_pic_idx 4 and ref_pic_idx≠ref_pic_idx 5, reference picture index ref_pic_idx 1 of the three or more identical indices is determined as the reference picture index of the current block. If there are not three or more identical reference picture indices among ref_pic_idx 1, ref_pic_idx 2, ref_pic_idx 3, ref_pic_idx 4 and ref_pic_idx 5, motion prediction is performed for each of the different reference picture indices, and a reference picture index indicating a picture with the better compression efficiency is determined as the reference picture of the current block.

Alternatively, reference picture index ref_pic_idx 1 of two or more identical reference pictures among ref_pic_idx 1, ref_pic_idx 2, ref_pic_idx 3, ref_pic_idx 4 and ref_pic_idx 5 may be determined as the reference picture index of the current block. At this time, if there are two groups, each formed with two identical reference picture indices, among ref_pic_idx 1, ref_pic_idx 2, ref_pic_idx 3, ref_pic_idx 4 and ref_pic_idx 5, that is, if ref_pic_idx 1=ref_pic_idx 2≠ref_pic_idx 5 and ref_pic_idx 3=ref_pic_idx 4≠ref_pic_idx 5, motion prediction is performed for each of ref_pic_idx 1 and ref_pic_idx 3, and a reference picture index indicating a picture with the better compression efficiency is determined as the reference picture of the current block. If ref_pic_idx 1, ref_pic_idx 2, ref_pic_idx 3, ref_pic_idx 4 and ref_pic_idx 5 are all different, motion prediction is performed for all the indices, and then, a reference picture index indicating a picture with the better compression efficiency is determined as the reference picture of the current block.

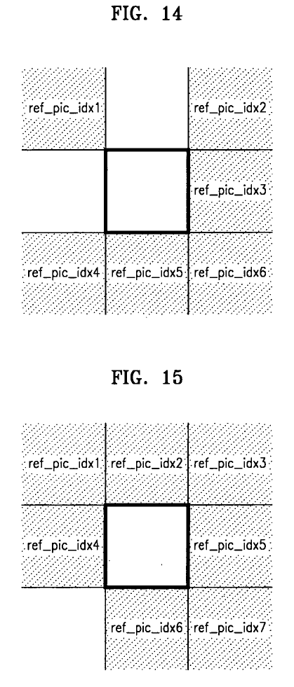

FIG. 14 shows an example where the number of blocks which are adjacent to the current block and for which reference pictures are already determined is 6. That is, if the number of such neighbor blocks is N, N is 6. When it is assumed that reference picture indices indicating the reference pictures of the six blocks are ref_pic_idx 1, ref_pic_idx 2, ref_pic_idx 3, ref_pic_idx 4, ref_pic_idx 5 and ref_pic_idx 6, respectively, in an arbitrary order, if four or more of ref_pic_idx 1, ref_pic_idx 2, ref_pic_idx 3, ref_pic_idx 4, ref_pic_idx 5 and ref_pic_idx 6 are identical, that is, for example, if ref_pic_idx 1=ref_pic_idx 2=ref_pic_idx 3=ref_pic_idx 4=ref_pic_idx 5=ref_pic_idx 6, or if ref_pic_idx 1=ref_pic_idx 2=ref_pic_idx 3=ref_pic_idx 4=ref_pic_idx 5≠ref_pic_idx 6, or if ref_pic_idx 1=ref_pic_idx 2=ref_pic_idx 3=ref_pic_idx 4 ref_pic_idx 5 and ref_pic_idx 1≠ref_pic_idx 6, the reference picture index of the four or more identical indices is determined as the reference picture index of the current block. If there are two groups, each group formed with three identical reference picture indices, among ref_pic_idx 1, ref_pic_idx 2, ref_pic_idx 3, ref_pic_idx 4, ref_pic_idx 5 and ref_pic_idx 6, that is, for example, if ref_pic_idx 1=ref_pic_idx 2=ref_pic_idx 3≠ref_pic_idx 4=ref_pic_idx 5=ref_pic_idx 6, motion prediction is performed for each of ref_pic_idx 1 and ref_pic_idx 4, and a reference picture index indicating a picture with the better compression efficiency is determined as the reference picture of the current block.

If only three among ref_pic_idx 1, ref_pic_idx 2, ref_pic_idx 3, ref_pic_idx 4, ref_pic_idx 5 and ref_pic_idx 6 are identical, that is, for example, if ref_pic_idx 1=ref_pic_idx 2=ref_pic_idx 3≠ref_pic_idx 4, ref_pic_idx 1≠ref_pic_idx 5, ref_pic_idx 1≠ref pic_idx 6, and ref_pic_idx 4 ref_pic_idx 5, reference picture index ref_pic_idx 1 of the identical three is determined as the reference picture index of the current block. Among ref_pic_idx 1, ref_pic_idx 2, ref_pic_idx 3, ref_pic_idx 4, ref_pic_idx 5 and ref_pic_idx 6, if there are three groups, each group formed with two identical indices, or if there are two groups, each group formed with two identical indices, or if there are only two identical indices, or if the indices are all different, motion prediction is performed for all the different indices, and a reference picture index indicating a picture with the better compression efficiency is determined as the reference picture of the current block.

FIG. 15 shows an example where the number of blocks which are adjacent to the current block and for which reference pictures are already determined is 7. That is, if the number of such neighbor blocks is N, N is 7. When it is assumed that reference picture indices indicating the reference pictures of the seven blocks are ref_pic_idx 1, ref_pic_idx 2, ref_pic_idx 3, ref_pic_idx 4, ref_pic_idx 5, ref_pic_idx 6 and ref_pic_idx 7, respectively, in an arbitrary order, if four or more of ref_pic_idx 1, ref_pic_idx 2, ref_pic_idx 3, ref_pic_idx 4, ref_pic_idx 5, ref_pic_idx 6 and ref_pic_idx 7 are identical, that is, for example, if ref_pic_idx 1=ref_pic_idx 2=ref_pic_idx 3=ref_pic_idx 4=ref_pic_idx 5=ref_pic_idx 6=ref_pic_idx 7, or if ref_pic_idx 1=ref_pic_idx 2=ref_pic_idx 3=ref_pic_idx 4=ref_pic_idx 5=ref_pic_idx 6≠ref_pic_idx 7, or if ref_pic_{—idx 1=ref}_pic_idx 2=ref_pic_idx 3=ref_pic_idx 4=ref_pic_idx 5≠ref_pic_idx 6 and ref_pic_idx 1≠ref_pic_idx 7, or if ref_pic_idx 1=ref_pic_idx 2=ref_pic_idx 3=ref_pic_idx 4≠ref_pic_idx 5, ref_pic_idx 1≠ref_pic_idx 6, and ref_pic_idx 1≠ref_pic_idx 7, the reference picture index of the identical four or more indices is determined as the reference picture index of the current block. If there are no four or more identical reference picture indices among ref_pic_idx 1, ref_pic_idx 2, ref_pic_idx 3, ref_pic_idx 4, ref_pic_idx 5, ref_pic_idx 6 and ref_pic_idx 7, that is, for example, if there are two groups, each group formed with three identical reference picture indices, or if there is one group formed with three identical reference picture indices, or if there are three groups, each group formed with two identical reference picture indices, or if there are two groups, each group formed with two identical reference picture indices, or if there are two identical reference picture indices, or if there is one group formed with three identical reference picture indices and two groups, each group formed with two identical reference picture indices, or if there are one group formed with three identical reference picture indices and another group formed with two identical reference picture indices, or if the reference picture indices are all different, motion prediction is performed for each of all the different indices, and then, a reference picture index indicating a picture with the better compression efficiency is determined as the reference picture of the current block.

Alternatively, the reference picture index of three or more identical reference picture indices among ref_pic_idx 1, ref_pic_idx 2, ref_pic_idx 3, ref_pic_idx 4, ref_pic_idx 5, ref_pic_idx 6 and ref_pic_idx 7 may be determined as the reference picture of the current block. In this case, if there are two groups, each group formed with three identical reference picture indices among ref_pic_idx 1, ref_pic_idx 2, ref_pic_idx 3, ref_pic_idx 4, ref_pic_idx 5, ref_pic_idx 6 and ref_pic_idx 7, motion prediction is performed for each of the different indices, and a reference picture index indicating a picture with the better compression efficiency is determined as the reference picture of the current block. If there are not three or more identical reference picture indices among ref_pic_idx 1, ref_pic_idx 2, ref_pic_idx 3, ref_pic_idx 4, ref_pic_idx 5, ref_pic_idx 6 and ref_pic_idx 7, that is, for example, if there are three groups, each group formed with two identical reference picture indices, or if there are only two identical reference picture indices, or if the reference picture indices are all different, motion prediction is performed for each of all the different indices, and a reference picture index indicating a picture with the better compression efficiency is determined as the reference picture of the current block.

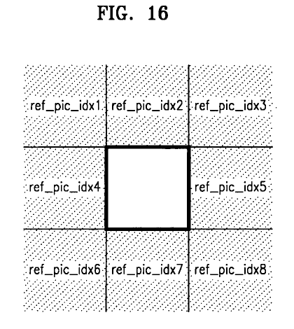

FIG. 16 shows an example where the number of blocks which are adjacent to the current block and for which reference pictures are already determined is 8. That is, if the number of such neighbor blocks is N, N is 8. When it is assumed that reference picture indices indicating the reference pictures of the eight blocks are ref_pic_{idx 1, ref}_pic_idx 2, ref_pic_idx 3, ref_pic_idx 4, ref_pic_idx 5, ref_pic_idx 6, ref_pic_idx 7 and ref_pic_idx 8, respectively, in an arbitrary order, if four or more of ref_pic_idx 1, ref_pic_idx 2, ref_pic_idx 3, ref_pic_idx 4, ref_pic_idx 5, ref_pic_idx 6, ref_pic_idx 7 and ref_pic_idx 8, are identical, reference picture index ref_pic_idx 1 of the four or more identical reference picture indices is determined as the reference picture index of the current block. At this time, if there are four groups, each group formed with two identical reference picture indices, among ref_pic_idx 1, ref_pic_idx 2, ref_pic_idx 3, ref_pic_idx 4, ref_pic_idx 5, ref_pic_idx 6, ref_pic_idx 7 and ref_pic_idx 8, that is, for example, if ref_pic_idx 1=ref_pic_idx 2=ref_pic_idx 3=ref_pic_idx 4≠ref_pic_idx 5=ref_pic_idx 6=ref_pic_idx 7=ref_pic_idx 8, motion prediction is performed for each of ref_pic_idx 1 and ref_pic_idx 5, and a reference picture index indicating a picture with the better compression efficiency is determined as the reference picture of the current block. If there are not four or more identical reference picture indices among ref_pic_idx 1, ref_pic_idx 2, ref_pic_idx 3, ref_pic_idx 4, ref_pic_idx 5, ref_pic_idx 6, ref_pic_idx 7 and ref_pic_idx 8, motion prediction is performed for each of all the different indices, and a reference picture index indicating a picture with the better compression efficiency is determined as the reference picture of the current block.

The methods described above can be generalized as the following:

<Method 1>

1. N reference picture indices of N neighbor blocks which are adjacent to a current block and for which reference picture indices are already determined are obtained (where N is an integer).

2. If there are the same number of identical reference picture indices as integer[N/2] among N reference picture indices, the reference picture index of the identical indices is determined as the reference picture index of the current block (Here, integer[ ] indicates rounding down to the nearest integer).

3. If there is a plurality of the same number of identical reference picture indices as integer[N/2] among N reference picture indices, motion prediction is performed for each of the reference picture indices and a reference picture index having the highest compression efficiency is determined as the reference picture index of the current block.

4. If there is not the same number, or more, of identical reference picture indices as integer[N/2] among N reference picture indices, motion prediction is performed for each different reference picture indices and a reference picture index having the highest compression efficiency is determined as the reference picture index of the current block.

<Method 2>

1. N reference picture indices of N neighbor blocks which are adjacent to a current block and for which reference picture indices are already determined are obtained (N is an integer).

2. If there are the same number of identical reference picture indices as integer[(N/2)+1] among N reference picture indices, the reference picture index of the identical indices is determined as the reference picture index of the current block (Here, integer[ ] indicates rounding down to the nearest integer).

3. If there is not the same number, or more, of identical reference picture indices as integer[(N/2)+1] among N reference picture indices, motion prediction is performed for each of different reference picture indices and a reference picture index having the highest compression efficiency is determined as the reference picture index of the current block.

In addition, even when a neighbor block of a current block is defined as explained referring to FIG. 9, the reference picture for the remaining blocks can be determined in the same manner as in FIG. 8. Further, when the number of neighbor blocks for which reference pictures are already determined is one, the reference picture index of the neighbor block can be determined as the reference picture index of the current block.

Meanwhile, by using the thus determined reference picture, the coding apparatus of FIG. 1 performs motion prediction for calculating a motion vector, and by using the calculated motion vector and the determined reference picture, performs motion compensation. That is, the motion prediction unit 600 of FIG. 1 calculates a motion vector by using the reference picture thus determined, and the motion compensation unit 500 performs motion compensation by using the calculated motion vector and the reference picture thus determined.

In addition, the decoding apparatus of FIG. 2 performs motion compensation by using the reference picture determined as described above and the corresponding motion vector. That is, the motion compensation unit 510 of FIG. 2 performs motion compensation by using the motion vector and the reference picture.

The method for determining a reference picture and a motion compensation method described above may be embodied in a computer program. The codes and code segments forming the program can be easily inferred by a computer programmer in the field of the art. In addition, the program can be stored in a computer readable medium that can be read by a computer, and by being read and executed by a computer, the program implements the method for determining a reference picture and a motion compensation method using the same. The computer readable recording medium includes various recording apparatuses on which computer readable data are stored such as magnetic storage media, optically readable media and carrier wave media.

According to the present invention as described above, based on the fact that it is highly probable that the reference picture of a current block is determined as any one of reference pictures of neighbor blocks, reference pictures only for partial blocks forming a current picture are first obtained and reference pictures for the remaining blocks are obtained as described above such that the efficiency of compression improves and complexity of computation can be reduced in coding and decoding data.

What is claimed is:

1. A method for determining reference pictures for a plurality of blocks forming a current picture comprising:
determining reference pictures for one or more of the plurality of blocks; and
determining a frequent reference picture that is most frequently selected among reference pictures of blocks which are adjacent to other, remaining, blocks and for which reference pictures are already determined, as the reference picture of the remaining blocks.

2. The method of claim 1, wherein in determining the reference picture of the remaining blocks, if there are a plurality of reference pictures that are most frequently selected, a picture which is selected among the plurality of reference pictures according to a predetermined criterion is determined as the reference picture.

3. The method of claim 1, wherein in determining the reference picture of the remaining blocks, if the reference pictures of the blocks which are adjacent to the remaining blocks and for which reference pictures are already determined are all different, a picture which is selected among the different reference pictures according to a predetermined criterion is determined as the reference picture of the remaining blocks.

4. The method of claim 3, wherein in determining the reference picture of the remaining blocks, a picture having the highest compression efficiency for the remaining blocks is determined as the reference picture.

5. The method of claim 1, wherein determining the reference picture of the remaining blocks comprises:
obtaining N reference picture indices indicating reference pictures of blocks which are adjacent to the current block and for which reference pictures are already determined;
if there are the same number of identical reference picture indices as integer[N/2] among N reference picture indices, determining the reference picture index of the identical indices as the reference picture index of the current block;
if there are a plurality of the same number of identical reference picture indices as integer[N/2] among N reference picture indices, performing motion prediction for each of the reference picture indices and then, determining a reference picture index having the highest compression efficiency as the reference picture index of the current block; and
if there is not the same number or more of identical reference picture indices as integer[N/2] among N reference picture indices, performing motion prediction for each of the different reference picture indices; and
determining a reference picture index having the highest compression efficiency as the reference picture index of the current block, wherein integer[ ] indicates rounding down to the nearest integer.

6. The method of claim 1, wherein determining the reference picture of the remaining blocks comprises:
obtaining N reference picture indices indicating reference pictures of blocks which are adjacent to the current block and for which reference pictures are already determined;
if there are the same number of identical reference picture indices as integer[(N/2)+1] among N reference picture indices, determining the reference picture index of the identical indices as the reference picture index of the current block; and
if there is not the same number or more of identical reference picture indices as integer[(N/2)+1] among N reference picture indices, performing motion prediction for each of the different reference picture indices and determining a reference picture index having the highest compression efficiency as the reference picture index of the current block, wherein integer[ ] indicates rounding down to the nearest integer.

7. The method of claim 1, wherein the determining the reference picture of the remaining blocks comprises:
calculating the number N of blocks which are adjacent to the current block and for which reference pictures are already determined; and
when N=2, if the reference pictures of two blocks are identical, determining the reference picture as the reference picture of the remaining blocks and if the reference pictures of the two blocks are different, determining a picture having a better compression efficiency as the reference picture of the remaining blocks.

8. The method of claim 1, wherein determining the reference picture of the remaining blocks comprises:
calculating a number N of blocks which are adjacent to the current block and for which reference pictures are already determined; and
when N=4, if two or more reference pictures of the blocks are identical, determining the reference picture of the two or more identical reference pictures as the reference picture of the remaining blocks;
when N=4, if the reference pictures of the blocks are divided into two groups, each formed with two identical reference pictures, determining a reference picture having a better compression efficiency between the two different reference-pictures, as the reference picture of the remaining blocks.

9. The method of claim 1, wherein determining the reference picture of the remaining blocks comprises:
calculating a number N of blocks which are adjacent to the current block and for which reference pictures are already determined; and
when N=6, if the reference pictures of the blocks are divided into three groups, each formed with two identical reference pictures, determining a reference picture having the highest compression efficiency among the three different reference pictures, as the reference picture of the current block, and if the reference pictures of the blocks are divided into two groups, each formed with three identical reference pictures, determining a reference picture having a better compression efficiency between the two different reference pictures, as the reference picture of the current block.

10. The method of claim 1, wherein determining the reference picture of the remaining blocks comprises:
calculating a number N of blocks which are adjacent to the current block and for which reference pictures are already determined; and
when N=8, if the reference pictures of the blocks are divided into four groups, each formed with two identical reference pictures, determining a reference picture having the highest compression efficiency among the four different reference pictures, as the reference picture of the current block, and if the reference pictures of the blocks are divided into two groups, each formed with three identical reference pictures, and one group formed with two identical reference pictures, determining a reference picture having the highest compression efficiency among the three reference pictures different from each other, as the reference picture of the current block, and if the reference pictures of the blocks are divided into two groups, each formed with four identical reference pictures, determining a picture having a better compression efficiency between the two different reference pictures, as the reference picture of the current block.

11. A method for performing motion compensation comprising:
reading a reference picture which is obtained by first determining reference pictures for part of a plurality of blocks forming a current picture, and then determining a reference picture that is most frequently selected among reference pictures of blocks which are adjacent to the remaining blocks and for which reference pictures are already determined, as the reference picture of the remaining blocks; and
by using the read reference picture and a motion vector corresponding to the reference picture, performing motion compensation.

12. The method of claim 11, wherein in determining the reference picture, if there is a plurality of reference pictures that are most frequently selected, a picture having the highest compression efficiency among the plurality of reference pictures is determined as the reference picture.

13. The method of claim 11, wherein in determining the reference picture, if the reference pictures of the blocks which are adjacent to the remaining blocks and for which reference pictures are already determined are all different, a picture having the highest compression efficiency among the different reference pictures is determined as the reference picture.

14. The method of claim 11, wherein the picture has a structure according to any one of a progressive scanning frame, an interlaced scanning frame, a top field, and a bottom field, and the block is structured according to any one of a macroblock, and sub-blocks obtained by equally dividing or quartering the macroblock.

15. An apparatus for coding moving picture data comprising:
a motion prediction unit which first determines reference pictures for some of a plurality of blocks included in a picture forming the moving picture data, determines a reference picture that is most frequently selected among reference pictures of blocks which are adjacent to the remaining blocks and for which reference pictures are already determined, as the reference picture of the remaining blocks, and calculates a motion vector for the block from the determined reference picture;
a memory unit operable to store the reference picture determined by the motion prediction unit; and
a motion compensation unit operable to perform motion compensation by using the motion vector calculated by the motion prediction unit and the reference pictures stored in the memory unit.

16. The apparatus of claim 15, wherein if there is a plurality of reference pictures that are most frequently selected, the motion prediction unit determines a picture having the highest compression efficiency among the plurality of reference pictures as the reference picture.

17. The apparatus of claim 15, wherein if the reference pictures of the blocks which are adjacent to the blocks and for which reference pictures are already determined are all different, the motion prediction unit determines a picture having the highest compression efficiency among the different reference pictures as the reference picture.

18. An apparatus for decoding a bitstream containing coded moving picture data comprising:
a memory unit operable to store reference picture indices indicating reference pictures, which are determined by first determining reference pictures for some of a plurality of blocks included in a current picture forming the moving picture data, determining a reference picture that is most frequently selected among reference pictures of blocks which are adjacent to the remaining blocks and for which reference pictures are already determined, as the reference picture of the remaining blocks, and reference pictures indicated by the reference pictures indices;
a motion vector decoding unit which decodes a motion vector extracted from the bitstream; and
a motion compensation unit which performs motion compensation by using a reference picture read from the memory unit and a corresponding motion vector provided by the motion vector decoding unit.

19. The apparatus of claim 18, wherein if there is a plurality of reference pictures that are most frequently selected, the reference picture index indicates a picture having the highest compression efficiency among the plurality of reference pictures.

20. The apparatus of claim 18, wherein if the reference pictures of the blocks which are adjacent to the current block and for which reference pictures are already determined are all different, the reference picture index indicates a picture having the highest compression efficiency among the different reference pictures.
